(19) United States
(12) Patent Application Publication
(10) Pub. No.: US 2013/0233055 A1
(43) Pub. Date: Sep. 12, 2013

(54) GAS CHROMATOGRAPH

(71) Applicant: SHIMADZU CORPORATION, Kyoto (JP)

(72) Inventor: YUSUKE TAKEMORI, KYOTO (JP)

(73) Assignee: SHIMADZU CORPORATION, Kyoto (JP)

(21) Appl. No.: 13/670,439

(22) Filed: Nov. 6, 2012

(30) Foreign Application Priority Data
Mar. 8, 2012 (JP) 2012-051903

(51) Int. Cl. G01N 30/18

(52) U.S. Cl. 73/23.41

(57) ABSTRACT

In gas chromatographic analysis, the consumption of a sample and the consumption of a carrier gas are reduced. In a direct injection unit (8), a small-capacity syringe (11) having a volume that exceeds 0 μl and is less than or equal to 0.5 μl , and a small-capacity insert (7) having a volume that exceeds 0 ml and is less than or equal to 0.4 ml are used. Besides, in a split injection unit (28), a small-capacity syringe (11) having a volume that exceeds 0 μl and is less than or equal to 0.5 μl and a small-capacity insert (7) having a volume that exceeds 0 ml and is less than or equal to 0.4 ml are used, and the split ratio during analysis is less than or equal to 3.

### CROSS-REFERENCE TO RELATED APPLICATION

This application claims the priority benefit of Japan application serial no. 2012-051903, filed on Mar. 8, 2012. The entirety of the above-mentioned patent application is hereby incorporated by reference herein and made a part of the specification.

### BACKGROUND OF THE INVENTION

1. Field of the Invention

The present invention relates to a gas chromatograph, and in particular, to a method for gas chromatographic analysis.

2. Description of Related Art

A gas chromatograph, serving as an analyzer, is a device that functions as follows: a carrier gas as a mobile phase is made to flow continuously in a column filled with a stationary phase and instantaneously a sample is guided into the column from the inlet of the column. As such, during the time when the sample and the mobile phase are moving together in the column, the difference of the movement speed resulted from the difference of the absorbability (affinity) or the partition coefficient of each constituent for the stationary phase is utilized to separate constituents from each other and perform quantitative and qualitative analysis.

A sample injection method of gas chromatographic analysis mainly includes a split injection method and a direct injection method (a full injection method). The split injection method is to guide the sample and the carrier gas, and to split (discard) a part of the sample and the carrier gas, so as to achieve the optimal movement speed of the sample. Besides, the direct injection method is an analysis method that can handle the case of analyzing a micro-constituent or analyzing a thin concentrated sample, namely, the case that the analysis is hindered because the sample is too little to be effectively split when splitting (discarding) is performed. Generally, about 80% of the analysis method that is being used is the split injection method.

FIG. 4 shows a schematic view of a conventional gas chromatograph including a split injection unit. A gas chromatograph 50 includes an oven 41, a split injection unit 48 arranged on the upper side of the oven 41, a detector part 43 and a column 44. The split injection unit 48 includes: a sample evaporation chamber 42 including a sample injection part 45, a carrier gas guiding path 46 and a split flow path 52; and an insert 47 propped in the sample evaporation chamber 42 by using a seal ring 49, and the split injection unit 48 and the detector part 43 are respectively sealed and connected to the two ends of the column 44.

In the split injection unit 48, the sample, injected from the sample injection part 45 by using a syringe 51, and the carrier gas pass through the sample evaporation chamber 42 and the insert 47 together and are guided into the detector part 43 though the column 44. In the gas chromatographic analysis, the optimal movement speed of the sample for analysis in the column has been decided. In the gas chromatograph 50, by injecting the sample from the sample injection part 45, injecting the carrier gas from the carrier gas guiding path 46, and discarding a portion of the sample and the carrier gas from the split flow path 52, the optimal movement speed of the sample in the column 44 is achieved.

Besides, the analysis conditions of the conventional split injection method are: the sample injection volume is about 1 μl; the insert volume is about 0.8 ml; the size of the column is about 0.1 mm to 0.53 mm; and the split ratio is about 40. In addition, the split ratio denotes the proportion of the split (discarded) volume relative to the volume of the sample and the carrier gas used for analysis. Therefore, that the split ratio is 40 means that the discarded amount is 40 times of the used amount.

FIG. 5 shows a schematic view of a conventional gas chromatograph including a direct injection unit. A gas chromatograph 70 includes an oven 61, a direct injection unit 68 arranged on the upper side of the oven 61, a detector part 63, and a column 64. The direct injection unit 68 includes: a sample evaporation chamber 62 including a sample injection part 65 and a carrier gas guiding path 66; and an insert 67 propped in the sample evaporation chamber 62 by using a seal ring 69, and the direct injection part 68 and the detector part 63 are respectively sealed and connected to the two ends of the column 64.

In the direct injection unit 68, the sample, injected from the sample injection part 65 by using a syringe 71, and the carrier gas pass through the sample evaporation chamber 62 and the insert 67, and are guided into the detector part 63 though the column 64. In the gas chromatograph 70, the guided sample is not discarded and is used for analysis of a micro-constituent or a low-density sample. However, in order to assure the constituent volume needed for analysis is in the column 64, the micro-constituent or the low-density sample must be at a large flow rate to a certain extent. Therefore, the insert with a volume of 0.8 ml and a widebore capillary column with an inner diameter greater than or equal to 0.45 mm are used.

Besides, Japanese Patent No. 4840409 discloses a method for guiding the sample gas into the direct sample evaporation chamber from a soft sample container and continuously concentrating and analyzing the sample gas.

The split injection method achieves the optimal movement speed of the sample for analysis in the column by discarding a portion of the sample guided into the sample evaporation chamber and the carrier gas. Therefore, the method has the disadvantages that the unnecessary loss of the sample and carrier gas is increased. Especially, in the current situation, the reserves of helium gas which is used as the carrier gas have become less and less, thus it is necessary to reduce the wasting of the carrier gas. Besides, there also exists the case that only a small amount of the sample may be used, and the consumption amount of the sample is also required to be reduced. Therefore, for a sample analyzed by the split injection method, which is the most often used method, how to maintain the analysis accuracy and reduce the consumption of the sample and carrier gas, regardless the analysis method, has become a major issue.

### SUMMARY OF THE INVENTION

In order to solve the issue, the present invention provides a gas chromatograph, including: a direct injection unit which includes a sample injection part for injecting a sample by using a syringe, a carrier gas guiding path for guiding a carrier gas, a sample evaporation chamber for evaporating the injected sample and an insert; a column, wherein the evaporated sample is guided into the column; and a detector part which detects the sample passed through the column. The sample injection part includes a small-capacity syringe having a volume that exceeds 0 μl and is less than or equal to 0.5 μl, and the insert is a small-capacity insert having a volume that exceeds 0 ml and is less than or equal to 0.4 ml.

Furthermore, the present invention provides a gas chromatograph, including: a split injection unit which includes a sample injection part for injecting a sample by using a syringe, a carrier gas guiding path for guiding a carrier gas, a sample evaporation chamber for evaporating the injected sample, an insert, and a discharging path for discarding a mixed gas of the sample and the carrier gas; a column, into which the evaporated sample is guided; and a detector part for detecting the sample passing through the column. The sample injection part includes a small-volume syringe having a volume that exceeds 0 μl and is less than or equal to 0.5 μl, the insert is a small-volume insert having a volume that exceeds 0 ml and is less than or equal to 0.4 ml, and the split ratio during analysis is less than or equal to 3.

### EFFECT OF THE INVENTION

In a normal split injection method, the injection amount of analyzed sample is reduced by using a small-volume syringe with a volume exceeds 0 μ1 and is less than or equal to 0.5 μl and by performing analysis with the direct injection unit using a small-volume insert having a volume that exceeds 0 ml and is less than or equal to 0.4 ml. The analysis may be performed without splitting (discarding) the sample and the carrier gas. Therefore, the consumption of the sample and the carrier gas may be reduced.

In the split injection unit, the small-volume syringe having a volume that exceeds 0 μl and is less than or equal to 0.5 μl is used to reduce the injection volume. Further, the small-volume insert having a volume that exceeds 0 ml and is less than or equal to 0.4 ml is used, and the split ratio during the analysis is made less than or equal to 3. In this way, the consumption of the sample and the carrier gas may be reduced.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows a schematic view of a gas chromatograph including a direct injection unit according to an exemplary embodiment of the present invention.

FIG. 2 shows an example of performing hydrocarbon separation by using the gas chromatograph including a direct injection unit according to an exemplary embodiment of the present invention.

FIG. 3 schematically shows a split injection unit according to an exemplary embodiment of the present invention.

FIG. 4 shows a schematic view of a conventional gas chromatograph including a split injection unit.

FIG. 5 shows a schematic view of a conventional gas chromatograph including a direct injection unit.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

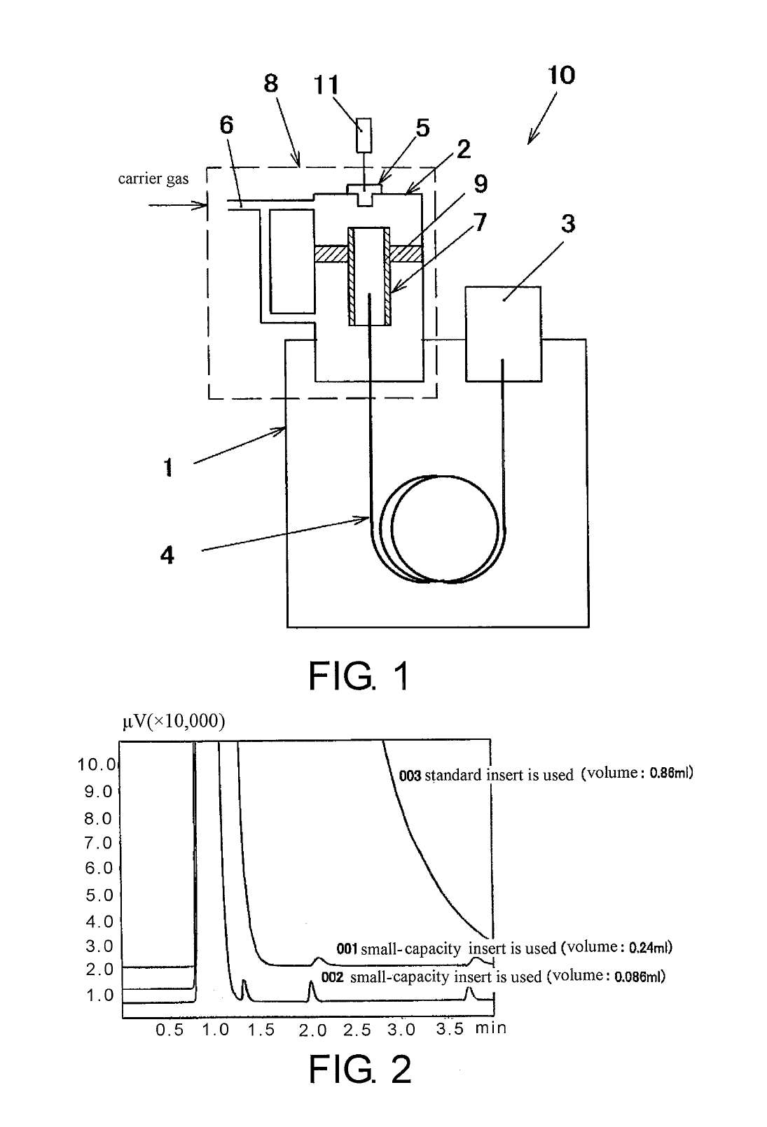

FIG. 1 shows a schematic view of a gas chromatograph including a direct injection unit according to an exemplary embodiment of the present invention. A gas chromatograph 10 includes an oven 1, a direct injection unit 8 arranged on the upper side of the oven 1, a detector part 3 and a column 4. The direct injection unit 8 includes: a sample evaporation chamber 2 which includes a sample injection part 5 and a carrier gas guiding path 6; and a small-volume insert 7 propped in the sample evaporation chamber 2 by using a seal ring 9. The direct injection unit 8 and the detector part 3 are respectively sealed and connected to the two ends of the column 4.

In the direct injection unit 8, the sample, injected from the sample injection part 5 by using a small-volume injector 11, and the carrier gas pass through the sample evaporation chamber 2 and the small-volume insert 7 and are guided into the detector part 3 through the column 4. Besides, the injected sample here is the sample analyzed by using a conventional split injection method; hence, the new use range of the direct injection method that is previously used only for a micro-constituent analysis or an analysis of the low-density sample is extended.

The direct injection unit 8 includes a small-capacity syringe 11 in which the volume is 0.5 μl, a small-capacity insert 7 in which the volume is 0.4 ml, and a column 4 of any size. Besides, with the reduction of the injection volume of the sample, the injection volume of the carrier gas is also reduced. Therefore, compared with the analysis condition of the conventional split injection method, the carrier gas is reduced to about one eighth (from about 28.6 ml/min to about 3.6 ml/min).

In addition, the small-capacity syringe with the volume value of 0.5 μl and the small-capacity insert with the volume value of 0.4 ml are used as the analysis conditions in an experiment of hydrocarbon separation and the data thereof are shown in FIG. 2. It can be deduced through the analysis method of the gas chromatograph that, by further reducing the volume, the analysis may still be performed in the accuracy of the same degree. Therefore, in the direct injection unit 8, the small-capacity syringe in which the volume exceeds 0 μl and is less than or equal to 0.5 μl may be used as the small-capacity syringe 11 and the small-capacity insert in which the volume exceeds 0 ml and is less than or equal to 0.4 ml may be used as the small-capacity insert 7.

FIG. 2 shows an example of performing hydrocarbon separation by using the gas chromatograph including a direct injection unit according to an exemplary embodiment of the present invention. The analysis conditions include: using a column with an inner diameter of 0.32 mm, using a small-capacity insert, and using a small-capacity syringe to guide about 0.02 μl of the sample, and the hydrocarbon is separated. For the sake of comparison, a conventional insert with a volume of 0.86 ml is used and the data is also shown in FIG. 2. The insert is compared with that in the previous example, so data occurring when the volume of the previous insert is 0.86 ml is also obtained. Besides, a small-capacity insert with a volume of 0.24 ml and another small-capacity insert with a volume of 0.086 ml are used and the data thereof are illustrated.

The curve 003 in FIG. 2 denotes that the sample injection volume is reduced to 0.02 μl and a conventional standard insert volume 0.86 ml is used. In that case, the shifting speed toward the column becomes slower and the peak becomes wider. In the curve 001 and the curve 002, according to the volumes of the small-capacity insert being smaller, the shifting speed toward the column becomes faster and the peaks become sharper, and the separation on the same degree with that in the conventional split analysis may be obtained.

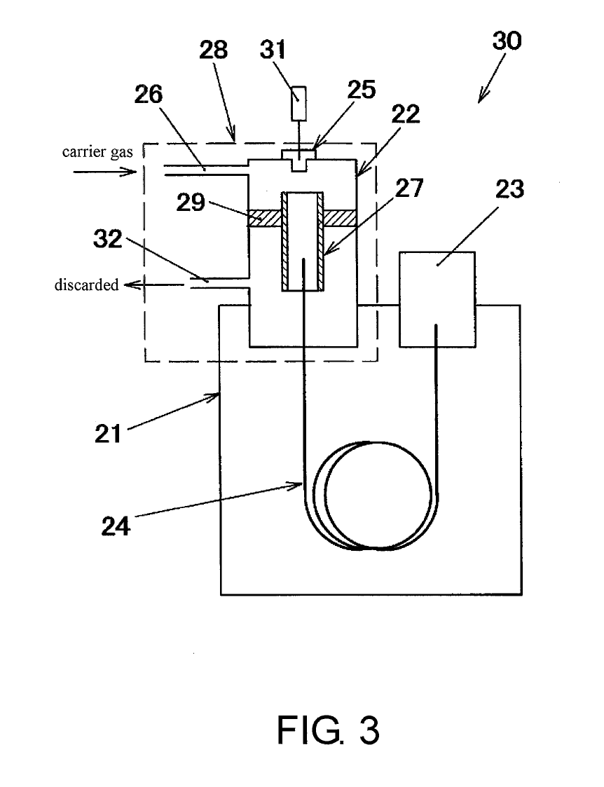

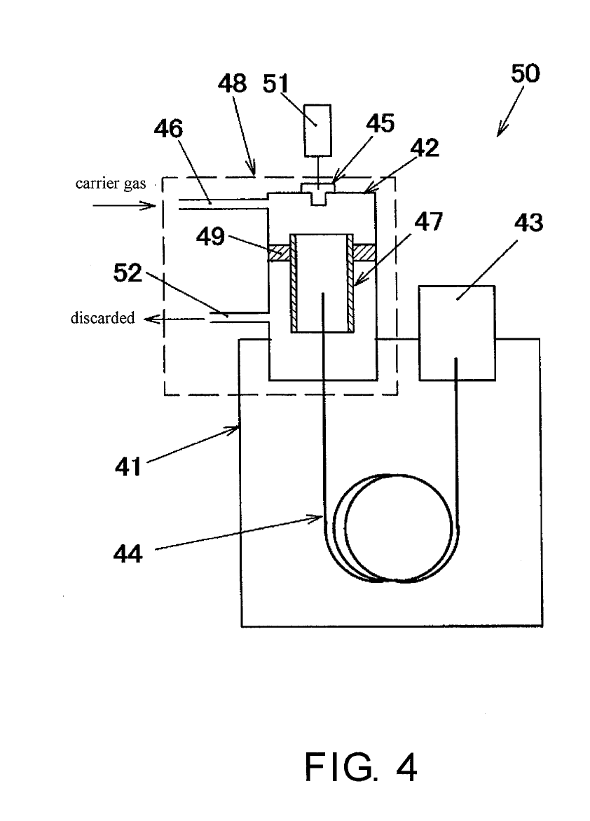

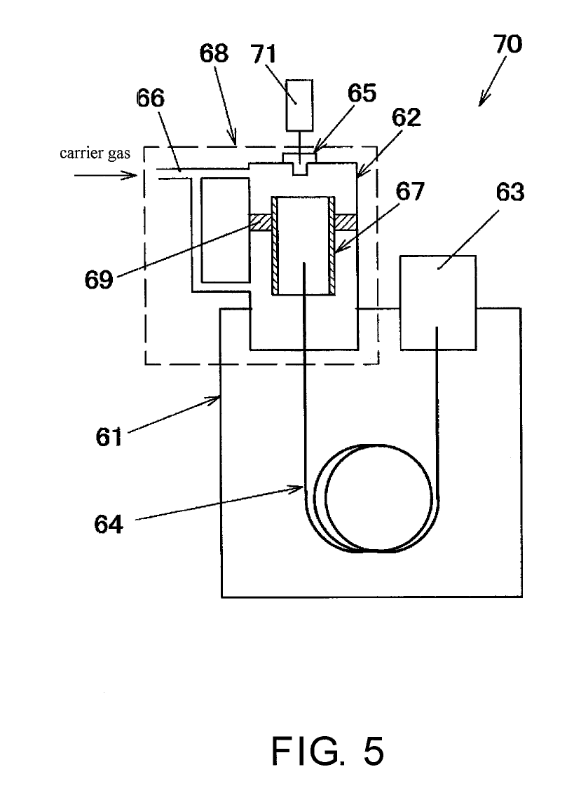

FIG. 3 shows a schematic view of a split injection unit according to an exemplary embodiment of the present invention. A gas chromatograph 30 includes an oven 21, a split injection unit 28 arranged on the upper side of the oven 21, a detector part 23 and a column 24. The split injection unit 28 includes: a sample evaporation chamber 22 including a sample injection part 25, a carrier gas guiding path 26 and a split flow path 32; and a small-capacity insert 27 propped in the sample evaporation chamber 22 by using a seal ring 29, wherein the split injection unit 28 and the detector part 23 are respectively sealed and connected to the two ends of the column 24.

In the split injection unit 28, the sample, injected from the sample injection part 25 by using a small-capacity syringe 31, and the carrier gas pass though the sample evaporation chamber 22 and the small-capacity insert 27, and are guided into the detector part 23 through the column 24.

The split injection unit 28 includes a small-capacity syringe 31 in which the volume is 0.5 μl, a small-capacity insert 27 in which the volume is 0.4 ml and a column of any size 24. And the analysis is performed with the split ratio of 3. Furthermore, compared with the analysis condition of the conventional split injection method, the carrier gas is reduced to about one fifth (from about 28.6 ml/min to about 5.5 ml/min)

In addition, a small-capacity syringe with a volume of 0.5 μl, a small-capacity insert with a volume of 0.4 ml and the split ratio of 3 are used as the analysis conditions in an experiment of confirming the analysis accuracy. It can be deduced through the analysis method of the gas chromatograph that, by further reducing the volume, an analysis still may be performed in the accuracy of the same degree. Therefore, in the split injection unit 28, the small-capacity syringe having a volume that exceeds 0 μl and is less than or equal to 0.5 μl may be used as the small-capacity syringe 31, and the small-capacity insert having a volume that exceeds 0 μl and is less than or equal to 0.4 ml may be used as the small-capacity insert 27, and the split ratio is less than or equal to 3 during analysis.

In the exemplary gas chromatograph 30 as shown in FIG. 3, compared with the exemplary gas chromatograph 10 as shown in FIG. 1, the injection volume of the sample and the carrier gas increases. However, it is considered that by discarding a portion of the sample and the carrier gas from the split flow path 32, the optimal movement speed of the sample in the column 24 is easy to be adjusted.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A gas chromatograph, comprising:
a direct injection unit comprising:
a sample injection part for injecting a sample by using a syringe;
a carrier gas guiding path for guiding a carrier gas;
a sample evaporation chamber for evaporating the sample which is injected; and
an insert;
a column, wherein the sample which is evaporated is guided into the column; and
a detector part which detects the sample that passes through the column,
wherein the sample injection part comprises a small-capacity syringe having a volume that exceeds 0 μl and is less than or equal to 0.5 μl and the insert is a small-capacity insert having a volume that exceeds 0 ml and is less than or equal to 0.4 ml.

2. A gas chromatograph, comprising:
a split injection unit comprising
a sample injection part for injecting a sample by using a syringe;
a carrier gas guiding path for guiding a carrier gas;
a sample evaporation chamber for evaporating the sample which is injected;
an insert; and
a discharging path for discarding a mixed gas of the sample and the carrier gas;
a column, wherein the sample which is evaporated is guided into the column; and
a detector part which detects the sample that passes through the column,
wherein the sample injection part comprises a small-capacity syringe having a volume that exceeds 0 μl and is less than or equal to 0.5 μl, the insert is a small-capacity insert having a volume that exceeds 0 ml and is less than or equal to 0.4 ml, and a split ratio during an analysis is less than or equal to 3.
